(19) United States
(12) Patent Application Publication
(10) Pub. No.: US 2006/0119988 A1
(43) Pub. Date: Jun. 8, 2006

(54) Head stack assembly incorporating a pivot assembly having solid lubrication

(76) Inventor: David Tsang, Cupertino, CA (US)

Correspondence Address: SAWYER LAW GROUP LLP, P O BOX 51418, PALO ALTO, CA, 94303, US

(21) Appl. No.: 11/040,728

(22) Filed: Jan. 21, 2005

Related U.S. Application Data
(60) Provisional application No. 60/538,157, filed on Jan. 22, 2004.

(51) Int. Cl. G11B 5/55

(52) U.S. Cl. 360/265.2

(57) ABSTRACT

A method and system for providing a disk drive pivot assembly is disclosed. The method and system include providing a sleeve, a shaft, and a solid lubrication. The sleeve includes a sleeve bearing surface that defines at least a portion of an aperture within the sleeve. The shaft has a shaft bearing surface and is rotatable with respect to the sleeve. The shaft bearing surface abuts the sleeve bearing surface. The solid lubrication resides between the shaft bearing surface and the sleeve bearing surface.

### CROSS-REFERENCE TO RELATED APPLICATION

This application is claiming under 35 USC 119(e) the benefit of provisional Patent Application Ser. No. 60/538,157, filed Jan. 22, 2004.

### FIELD OF THE INVENTION

The present invention relates to disk drives, and more particularly to a method and system for providing a pivot assembly utilizing solid lubrication.

### BACKGROUND OF THE INVENTION

FIGS. 1 and 2 depict a conventional disk drive, such as one which would be used in a computer system. FIG. 1 is a top view of the conventional disk drive 1. FIG. 2 is a side view of the conventional disk drive 1. Referring to FIGS. 1 and 2, the conventional disk drive 1 includes a base plate 2, a spindle motor assembly 3 disposed on the base plate 2, disks 4, heads 5, a head stack assembly 6, and top cover 2A. The spindle motor assembly 3 rotates the disks 4, for writing information to and reading data from the disks 4. The heads 5 are also used in reading from or writing to the disks 4. The head stack assembly 6 positions the heads 5 over the appropriate portion of the disks 4 for reading from or writing to the disks 4. The top cover 2A generally seals the disk drive 1.

The head stack assembly 6 includes a swing arm 7 having a cylindrical bore 8, a conventional pivot assembly 10 having a shaft 9. The heads 5 reside at the distal end of the swing arm 7. The conventional pivot assembly 10 includes ball bearings (not shown in FIGS. 1 and 2) and resides in the cylindrical bore 8 of the swing arm 7. The conventional pivot assembly 10 typically includes two single-row deep groove ball bearings fitted around a shaft 9 that is mounted on the base plate 2. Thus, the swing arm 7 can rotate around the shaft 9. A drive portion 11, for example including a voice coil motor, is used to actuate the swing arm 7, rotating the heads 5 into the desired position for reading and/or writing.

FIG. 3 is a more detailed diagram depicting a conventional pivot assembly 10. The conventional pivot assembly 10 is a ball bearing assembly. In particular, the conventional pivot assembly 10 includes two single-row deep groove ball bearings 12 and 13 around the shaft 9, and a sleeve 14. The ball bearings 12 and 13 are separated by a space S that generally has a predetermined length. The ball bearings 12 and 13 have an inner race 12A and 13A, respectively, as well as an outer race 12B and 13B, respectively. The balls 15 and 16 run within bearings 12 and 13, respectively. The shaft 9 includes body 9A and flange 9B. The sleeve 14 is cylindrical in shape and includes sleeve body 14A and annular projection 14B. The ball bearings 12 and 13 are in contact with the flange 9B at the end of the inner races 12A and 13A, respectively. At the ends of outer races 12B and 13B, the ball bearings 12 and 13, respectively are in contact with the sleeve body 14A. The annular projection 14B is configured to fit with the space S between the ball bearings 12 and 13. The shaft 9 is mounted to the base plate 2 at its flange 9B.

Although the conventional pivot assembly 10 functions, one of ordinary skill in the art will readily recognize that there are several drawbacks to its use that adversely affect performance and scalability. During use, dynamic vibrations are generated by physical contact between the balls 15 and 16 and races 12A, 12B, 13A, and 13B as the balls 15 and 16, respectively, roll in the races 12A, 12B, 13A, and 13B. Typically, lubrication is provided by bearing oil and grease. As a result, the balls 15 and 16 typically run macroscopically even and smooth in the races 12A, 12B, 13A, and 13B, respectively. However, on a microscopic level, the races 12A, 12B, 13A, and 13B may be uneven and rough. In addition, the shapes of the balls 15 and 16 may vary from spheres. These microscopic imperfections in the races 12A, 12B, 13A, and 13B, as well as imperfections in the sphericity of the balls 15 and 16, respectively, may cause vibrations. These vibrations adversely affect the performance of the conventional pivot assembly 10. Further, damage to the balls 15 and 16 may be incurred during shocks to the bearings 12 and 13. In particular, contact surfaces for the balls 15 and 16 are small. Pressures resulting from contact between the races 12A, 12B, 13A and 13B and the corresponding balls 15 and 16, respectively, may thus exceed the yield strength of the ball material. As a result, permanent deformation of the balls 15 and 16 and/or the races 12A, 12B, 13A, and 13B may occur. Such deformations adversely affect performance of the conventional pivot assembly 10. Moreover, the conventional pivot assembly 10 may be subject to non-repeatable error in writing and reading information at predetermined positions of the disks 4. In particular, misalignment of the bearings 12 and 13 around the shaft 9 induces runout of the swing arm 7 that is not repeatable. As a result, non-repeatable errors may occur in the position of the magnetic heads 5. Further, the physical size of the bearings 13 and 13 is also limited in scalability. In particular, the use of mechanical bearings 12 and 13 may be limited to fixed dimensions. As a result, it is difficult to reduce the size of the conventional pivot assembly 10 to be used in applications requiring smaller disk drives.

Accordingly, what is needed is a method and system for providing a pivot assembly that has improved performance and/or scalability. The present invention addresses such a need.

### BRIEF SUMMARY OF THE INVENTION

The present invention provides a method and system for providing a disk drive pivot assembly. The method and system comprise providing a sleeve, a shaft, and a solid lubrication. The sleeve includes a sleeve bearing surface that defines at least a portion of an aperture within the sleeve. The shaft has a shaft bearing surface and is rotatable with respect to the sleeve. The shaft bearing surface abuts the sleeve bearing surface. The solid lubrication resides between the shaft bearing surface and the sleeve bearing surface.

According to the method and system disclosed herein, the present invention provides a disk drive pivot assembly that has reduced vibration, reduced shock damage, and improved alignment.

### BRIEF DESCRIPTION OF SEVERAL VIEWS OF THE DRAWINGS

FIG. 1 is a top view of a disk drive in a computer system.

FIG. 2 is a side view of the disk drive of a computer system.

FIG. 3 is a diagram depicting a conventional disk drive pivot assembly.

FIG. 4 is a high level diagram depicting one embodiment of a pivot assembly in accordance with the present invention.

FIG. 5 is a diagram depicting a first embodiment of a pivot assembly in accordance with the present invention.

FIG. 6 is a diagram depicting a second embodiment of a pivot assembly in accordance with the present invention.

FIG. 7 is a diagram depicting a third embodiment of a pivot assembly in accordance with the present invention.

FIG. 8 is a diagram depicting a fourth embodiment of a pivot assembly in accordance with the present invention.

FIG. 9 is a flow chart depicting one embodiment of a method in accordance with the present invention for providing a pivot assembly.

### DETAILED DESCRIPTION OF THE INVENTION

The present invention relates to disk drive assemblies. The following description is presented to enable one of ordinary skill in the art to make and use the invention and is provided in the context of a patent application and its requirements. Various modifications to the preferred embodiments and the generic principles and features described herein will be readily apparent to those skilled in the art. Thus, the present invention is not intended to be limited to the embodiments shown, but is to be accorded the widest scope consistent with the principles and features described herein.

The present invention provides a method and system for providing a disk drive pivot assembly. The method and system comprise providing a sleeve, a shaft, and a solid lubrication. The sleeve includes a sleeve bearing surface that defines at least a portion of an aperture within the sleeve. The shaft has a shaft bearing surface and is rotatable with respect to the sleeve. The shaft bearing surface abuts the sleeve bearing surface. The solid lubrication resides between the shaft bearing surface and the sleeve bearing surface.

The present invention will be described in terms of particular embodiments of the disk drive pivot assembly. However, one of ordinary skill in the art will readily recognize that the method and system are consistent with other components having analogous components and/or functions.

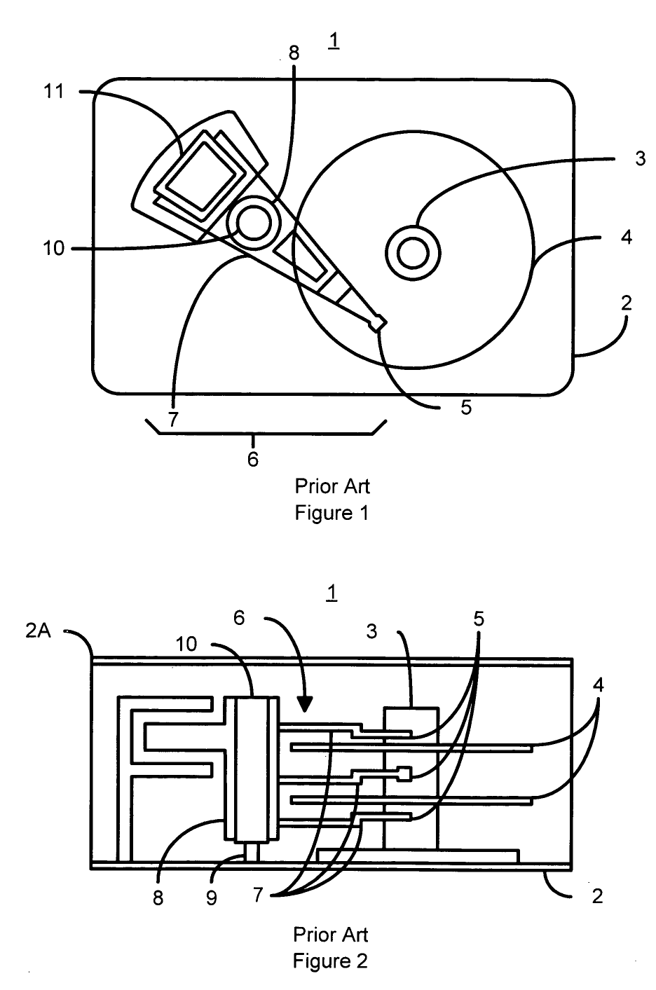

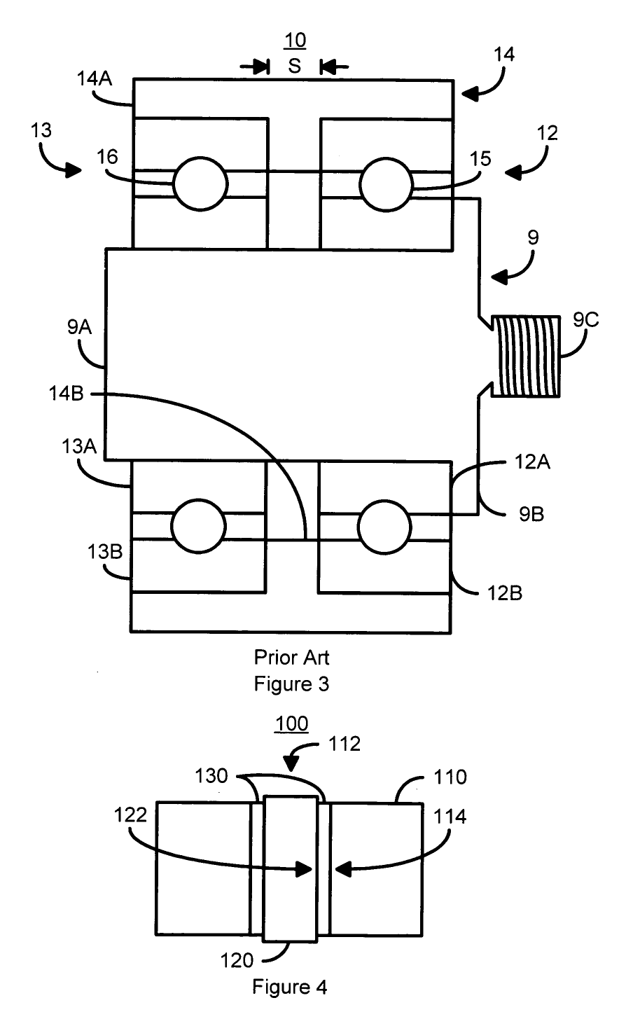

FIG. 4 is a high level diagram depicting one embodiment of a pivot assembly 100 in accordance with the present invention. The pivot assembly 100 may be used in a disk drive, such as the disk drive 1. The pivot assembly 100 includes a sleeve 110 and a shaft 120. The sleeve 110 has an aperture 112 into which the shaft 120 fits. The sleeve 110, aperture 112 and shaft 120 are preferably cylindrical in shape. The sleeve 110 and shaft 120 can rotate with respect to each other. In addition, the sleeve 110 or the shaft 120 may have a flange (not shown). In addition, either the sleeve 110 or the shaft 120 may be attached to the disk drive. Consequently, the pivot assembly 100 may be used to drive a swing arm such as the swing arm 7 depicted in FIGS. 1 and 2. Referring back to FIG. 4, the disk drive 100 also includes solid lubrication 130. The solid lubrication 130 resides in the space between the sleeve 110 and the shaft 120. Stated differently, the solid lubrication 130 resides between the wear surfaces 114 and 122 of the sleeve 110 and the shaft 120, respectively, the regions in which the sleeve 110 and shaft 120 might wear due to the relative motion between the sleeve 110 and the shaft 120. The solid lubrication 130 might include solid lubricants that are applied to the region and/or thin films, such as carbon, deposited on the wear surfaces. Further, in some embodiments, the shaft may have an undercut region (not shown) to reduce the size of the wear surfaces between the shaft 120 and sleeve 110.

Because of the use of the solid lubrication 130 in conjunction with the shaft 120 and sleeve 110, the use of ball bearings can be avoided. Consequently, the problems of runout, vibration, and/or deformation of the balls or races may be avoided. In addition, the pivot assembly 100 may have be made smaller and, therefore, my be capable of being used in smaller disk drives. Consequently, performance and scalability of the pivot assembly 100 may be improved. Moreover, the pivot assembly 100 is relatively simple in the design, thereby facilitating manufacturing and assembly. The number of parts 110, 120, and 130 of the pivot assembly 100 is also relatively low. Thus, cost and assembly time may be reduced.

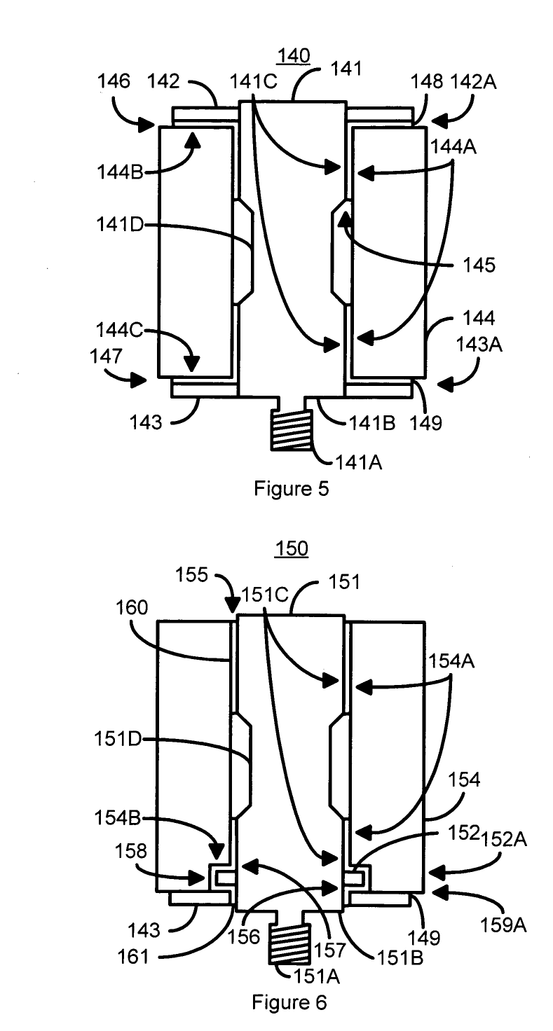

FIG. 5 is a diagram depicting a first embodiment of a pivot assembly 140 in accordance with the present invention. The pivot assembly 140 includes a central shaft 141 and a sleeve 144 that rotates with respect to the shaft 141. In the pivot assembly 140, the shaft 141 is preferably fixed, for example to a base plate (not shown), while the sleeve 144 can rotate.

The shaft 141 preferably has thrust plates 142 and 143 mounted on each end. The shaft 141 preferably includes a threaded mounting end 141A that is configured to through an opening in the base plate of a disk drive (not shown). In such an embodiment, a nut (not shown) may be threaded on the extension 141A to affix the shaft 141 to the base plate. In another embodiment, other means of attaching the extension 141A and/or the shaft 141 to the base plate are available. For example an interference fit, retaining clip, glue, or other mechanisms might be used. At this end, the shaft 141 also preferably includes a shoulder 141B which preferably rests on an upraised portion (not shown) of a base plate (not shown), such as the base plate 2 depicted in FIGS. 1 and 2. Referring back to FIG. 5, the shaft 141 includes contact surface(s) 141C at which the shaft 141 may contact the sleeve 144. The shaft 141 also preferably has an undercut 141D near the central portion of shaft 141. The undercut 141D is configured to reduce friction and wear between the shaft 141 and the sleeve 144.

The sleeve 144 is preferably cylindrical in shape. A swing arm (not shown), such as the swing arm 7 depicted in FIGS. 1 and 2, is mounted to the sleeve 144. Referring back to FIG. 5, the swing arm is preferably mounted to the sleeve 144 by glue, interference fit, tolerance ring, screws, or in another manner. The sleeve 144 also includes contact surfaces 144A and 144B, which may contact the shaft 141 and thrust plate 142, respectively.

In the configuration shown, the contact surfaces 141C and 144A of the shaft 141 and the sleeve 144 define where the shaft 141 and sleeve 144 might contact at a gap 145. The gaps 146 and 147 exist between the thrust plates 142 and 143, respectively, and the sleeve 144. Consequently, solid lubrication 148 and 149 resides between the contact surfaces 141C and 144A, as well as in the gaps 146 and 147. Alternatively, the solid lubrication can be applied in the form of film, as with techniques such as sputter deposition, diffusion, and surface treatments, to one (or both) of the contact surfaces 141C and 144A between the pivot shaft 141 and the surrounding sleeve 144. The solid lubrication may also be applied to at least one of the contact surfaces 142A and 144B between thrust plate 142 and sleeve 144, respectively, and/or to at least one of the contact surfaces 143A and 144C between the thrust plate 143 and the sleeve 144, respectively.

Thus, the pivot assembly 140 need not use ball bearings. Instead, the combination of the shaft 141, the sleeve 144, the thrust plates 142 and 143, and the solid lubrication 148 and 149 are used. Consequently, the problems of runout, vibration, and/or deformation of the balls or races may be avoided. In addition, the pivot assembly 140 may have be made smaller and, therefore, my be capable of being used in smaller disk drives. Consequently, performance and scalability of the pivot assembly 140 may be improved. Moreover, the pivot assembly 140 is relatively simple in the design, thereby facilitating manufacturing and assembly. The number of parts 141, 142, 143 and 144 of the pivot assembly 140 is also relatively low. Thus, cost and assembly time may be reduced.

FIG. 6 is a diagram depicting a second embodiment of a disk drive pivot assembly 150 in accordance with the present invention. The pivot assembly 150 includes a central shaft 151 and a sleeve 154 that rotates with respect to the shaft 151. Furthermore, the pivot assembly 150 includes a thrust plate 152 and a counterplate 159. Like the pivot assembly 140 depicted in FIG. 4, the shaft 151 is intended to be fixed to the disk drive, such as the base plate 2 depicted in FIGS. 1 and 2, while the sleeve 154 rotates.

Referring back to FIG. 6, the shaft 151 has the thrust plate 152 mounted on one end. The thrust plate 152 sits within a recess 158 defined by the sleeve 154 and the counterplate 159 mounted to the sleeve 154. At its distal end, the shaft 151 preferably includes a threaded mounting end 151A which extends through an opening in the base plate (not shown) of disk drive. A nut (not shown) may be threaded on the extension 151A to affix the shaft 151 in place within the base plate. In another embodiment, other means of attaching the extension 151A and/or the shaft 151 to the base plate are available. For example an interference fit, retaining clip, glue, or other mechanisms might be used. The shaft 151 preferably includes a shoulder 151B which rests on an upraised portion (not shown) of a base plate (not shown) such as the base plate 2 depicted in FIGS. 1 and 2. Referring back to FIG. 6, the shaft 151 also preferably includes contact surface(s) 151C at which the shaft 151 may contact the sleeve 144. In a preferred embodiment, the shaft 151 has an undercut 151D near the central portion of shaft 141. The undercut 151D is configured to reduce friction and wear between the shaft 151 and the sleeve 154.

The sleeve 154 is preferably cylindrical in shape. The sleeve 154 is also coupled to the counterplate 159. Although the counterplate 159 is preferably affixed to the sleeve 54 using glue, other mechanisms can be used. A swing arm (not shown), such as the swing arm 7 depicted in FIGS. 1 and 2, is mounted to the sleeve 154. Referring back to FIG. 6, the swing arm is preferably mounted to the sleeve 154 by glue, interference fit, tolerance ring, screws, or in another manner. The sleeve 154 also includes contact surfaces 154A and 154B, which may contact the shaft 151 and thrust plate 152, respectively.

In the configuration shown, the contact surfaces 151C and 154A of the shaft 151 and the sleeve 154 define where the shaft 151 and sleeve 154 might contact. Moreover, the sleeve 154 and thrust plate 152, as well as the counterplate 159 and thrust plate 152 may contact. Consequently, solid lubrication 160 resides between the contact surfaces 151C and 154A, in the gap 155. The solid lubrication 161 preferably also resides in gaps 156 and 157, which exist between the thrust plate 152 and the counterplate 159 and between the thrust plate 152 and the sleeve 154, respectively.

As discussed above, the solid lubrication preferably resides in one or more the areas described. The solid lubrication might also be applied, for example in the form of film. Techniques for providing such films include sputter deposition, diffusion, and surface treatments, to one (or both) of the contact surfaces 151C and 154A between the shaft 151 and the surrounding sleeve 154, and to one (or both) of the contact surfaces 152A and 154B between thrust plate 152 and the sleeve 154, and to one (or both) of the contact surfaces 152B and 159C between thrust plate 152 and counterplate 159.

Thus, the pivot assembly 150 need not use ball bearings. Instead, the combination of the shaft 151, the sleeve 154, the thrust plate 152 and counterplate 159, and the solid lubrication 160 and 161 are used. Consequently, the problems of runout, vibration, and/or deformation of the balls or races may be avoided. In addition, the pivot assembly 150 may have be made smaller and, therefore, my be capable of being used in smaller disk drives. Consequently, performance and scalability of the pivot assembly 150 may be improved. Moreover, the pivot assembly 150 is relatively simple in the design, thereby facilitating manufacturing and assembly. The number of parts of the pivot assembly 150 is also relatively low. Thus, cost and assembly time may be reduced.

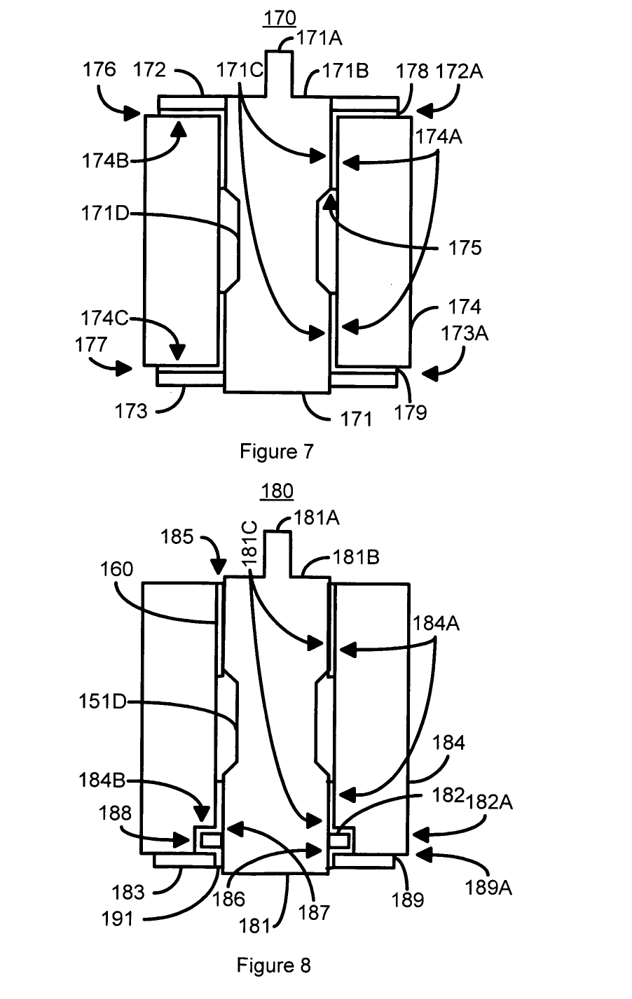

FIG. 7 is a diagram depicting a third embodiment of a disk drive pivot assembly 170 in accordance with the present invention. The pivot assembly 170 has a central rotating shaft 171, and a sleeve 174. The sleeve 174 is intended to be fixed to the disk drive, such as the base plate 2 depicted in FIGS. 1 and 2, while the shaft 171 can rotate.

The shaft 171 has thrust plates 172 and 173 mounted on both ends. The shaft 171 also includes an extension 171A on which swing arm (not shown), such as the swing arm depicted in FIGS. 1 and 2, is mounted. Referring back to FIG. 7, the swing arm is preferably mounted to the extension 171A by, interference fit, tolerance ring, screws, glue, or in another manner. The shaft 171 also preferably includes a shoulder 171B that supports the swing arm. The shaft 171 also includes contact surfaces 171C at which the shaft 171 may contact the sleeve 174. The shaft 171 has an undercut 171D at the center portion of the shaft 171 to minimize the friction and wear between the shaft 171 and the sleeve 174.

The shaft 171 rotates relative to the fixed cylindrical sleeve 174. The sleeve 174 is mounted to a base plate (not shown) by glue, interference fit, or the like. The sleeve 174 is also coupled to a base plate (not shown), such as the base plate 2 depicted in FIGS. 1 and 2. Although the sleeve 174 is preferably affixed to the sleeve 174 using glue, or interference fit, other mechanisms can be used. The sleeve 174 also includes contact surfaces 174A and 174B, which may contact the shaft 171 and thrust plate 172, respectively.

In the configuration shown, the contact surfaces 171C and 174A of the shaft 171 and the sleeve 174 define where the shaft 171 and sleeve 174 might contact at a gap 175. The gaps 176 and 177 exist between the thrust plates 172 and 173, respectively, and the sleeve 174. Consequently, solid lubrication 178 and 179 resides between the contact surfaces 171C and 174A, as well as in the gaps 176 and 177. In one embodiment, solid lubrication 178 and 179 might be applied in the form of film, for example using techniques such as sputter deposition, diffusion, and surface treatments. Thus, the solid lubrication 178 and 179 may be applied to at least one of the following: one or both of the contact surfaces 171C and 174A, between the pivot shaft 171 and the sleeve 174, and one or more of the contact surfaces 172A and 174C between thrust plate 172 and sleeve 174, and to one or both of the contact surfaces 173A and 174C between the thrust plate 173 and the sleeve 174.

Thus, the pivot assembly 170 need not use ball bearings. Instead, the combination of the shaft 171, the sleeve 174, the thrust plates 172 and 173, and the solid lubrication 178 and 179 are used. Consequently, the problems of runout, vibration, and/or deformation of the balls or races may be avoided. In addition, the pivot assembly 140 may have be made smaller and, therefore, my be capable of being used in smaller disk drives. Consequently, performance and scalability of the pivot assembly 140 may be improved. Moreover, the pivot assembly 170 is relatively simple in the design, thereby facilitating manufacturing and assembly. The number of parts 171, 172, 173 and 174 of the pivot assembly 170 is also relatively low. Thus, cost and assembly time may be reduced.

FIG. 8 is a diagram depicting a fourth embodiment of a disk drive pivot assembly 180 in accordance with the present invention. The pivot assembly 180 includes a central shaft 181 that rotates and a sleeve 184 that is fixed with respect to the shaft 151. Furthermore, the pivot assembly 180 includes a thrust plate 182 and a counterplate 189. Like the pivot assembly 170 depicted in FIG. 7, the sleeve 184 is intended to be fixed to the disk drive, such as the base plate 2 depicted in FIGS. 1 and 2, while the shaft 181 rotates.

Referring back to FIG. 7, the shaft 181 has the thrust plate 182 mounted on one end. The thrust plate 182 sits within a recess 188 defined by the sleeve 184 and the counterplate 189 mounted to the sleeve 184. The shaft 181 preferably includes an extension 181A on which a swing arm (not shown) is mounted on the shoulder 181P supporting the swing arm in place. In a preferred embodiment, the swing arm is mounted on the extension 181A using an interference fit, retaining clip, glue, or in another manner. The shaft 181 also preferably includes a shoulder 181B that supports the swing arm. The shaft 181 also preferably includes contact surface(s) 181C at which the shaft 181 may contact the sleeve 184. In a preferred embodiment, the shaft 181 has an undercut 151D near the central portion of shaft 181. The undercut 181D is configured to reduce friction and wear between the shaft 181 and the sleeve 184.

The shaft 181 rotates relative to the fixed cylindrical sleeve 184. The sleeve 184 is also coupled to a base plate (not shown), such as the base plate 2 depicted in FIGS. 1 and 2. Referring back to FIG. 8, the sleeve 184 also includes contact surfaces 184A and 184B, which may contact the shaft 181 and thrust plate 182, respectively. The sleeve 188 is mounted to a base plate (not shown) by glue, interference fit, or the like.

In the configuration shown, the contact surfaces 181C and 184A of the shaft 181 and the sleeve 184 define where the shaft 181 and sleeve 184 might contact at gap 185. The gaps 186 and 187 exist between the thrust plate 182 and the counterplate 189 and the thrust plate 182 and the sleeve 184, respectively. Moreover, the sleeve 184 and thrust plate 182, as well as the counterplate 189 and thrust plate 182 may contact. Consequently, solid lubrication 190 resides between the contact surfaces 181C and 184A, in the gaps 155. The solid lubrication 191 preferably also resides in gaps 186 and 187, which exist between the thrust plate 182 and the counterplate 189 and between the thrust plate 182 and the sleeve 184, respectively.

As discussed above, the solid lubrication preferably resides in one or more the areas described. The solid lubrication might also be applied, for example in the form of film. Techniques for providing such films include sputter deposition, diffusion, and surface treatments, to one (or both) of the contact surfaces 181C and 184A between the shaft 181 and the surrounding sleeve 184, and to one (or both) of the contact surfaces 182A and 184B between thrust plate 182 and the sleeve 184, and to one (or both) of the contact surfaces 182B and 189A between thrust plate 182 and counterplate 189.

Thus, the pivot assembly 180 need not use ball bearings. Instead, the combination of the shaft 181, the sleeve 184, the thrust plate 182, the counter plate 189, and the solid lubrication 190 and 191 are used. Consequently, the problems of runout, vibration, and/or deformation of the balls or races may be avoided. In addition, the pivot assembly 180 may have be made smaller and, therefore, my be capable of being used in smaller disk drives. Consequently, performance and scalability of the pivot assembly 140 may be improved. Moreover, the pivot assembly 180 is relatively simple in the design, thereby facilitating manufacturing and assembly. The number of parts of the pivot assembly 180 is also relatively low. Thus, cost and assembly time may be reduced.

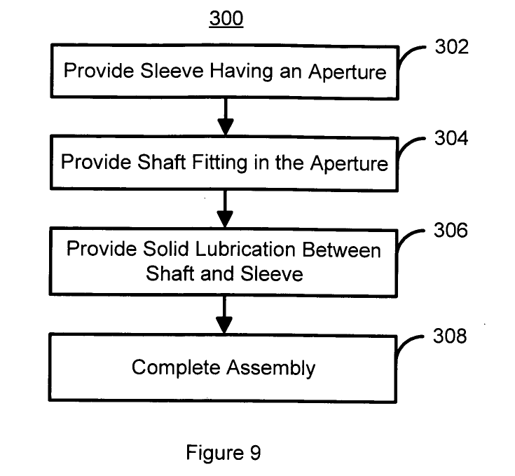

FIG. 9 is a flow chart depicting one embodiment of a method 300 in accordance with the present invention for providing a disk drive pivot assembly. The method 300 is described in the context of the pivot assembly 100 depicted in FIG. 4. However, the method 300 might be used to provide another pivot assembly in accordance with the present invention, such as the pivot assembly 140, 150, 170, and/or 180.

A sleeve 110 including an aperture 112 is provided, via step 302. The aperture 110 is defined to include at least one bearing surface. In one embodiment, step 302 includes providing a counterplate (not shown in FIG. 4) and affixing the counterplate to the sleeve 110. A shaft 120 is provided, via step 304. In one embodiment, step 304 includes providing a thrust plate (not shown in FIG. 4) or other portions of the shaft 110. The shaft is rotatable with respect to the sleeve 110. Thus, step 302 or 304 could affix the sleeve or aperture, respectively, to the disk drive (not shown in FIGS. 4 and 9). In addition a solid lubrication residing at least between the bearing surfaces of the shaft and the sleeve is provided, via step 306. The lubrication may be provided to the space between the shaft 120 and the sleeve 110 in the region of the air bearing surface. In addition, the solid lubrication might be provided directly to the bearing surface(s), for example, using sputter deposition, diffusion, and/or surface treatments. Assembly of the pivot assembly 100 as well as the disk drive may then be completed, via step 308.

Thus, the pivot assembly 100, 140, 150, 170, and/or 180 may be provided using the method 300. As a result, the benefits of the pivot assembly 100, 140, 150, 170, and/or 180 may be achieved.

A method and system for providing a disk drive pivot assembly has been disclosed. The present invention has been described in accordance with the embodiments shown, and one of ordinary skill in the art will readily recognize that there could be variations to the embodiments, and any variations would be within the spirit and scope of the present invention. Accordingly, many modifications may be made by one of ordinary skill in the art without departing from the spirit and scope of the appended claims.

We claim:

1. A disk drive pivot assembly comprising:
a sleeve having a sleeve bearing surface defining at least a portion of an aperture within the sleeve;
a shaft having a shaft bearing surface and being rotatable with respect to the sleeve, the shaft bearing surface abutting the sleeve bearing surface;
a solid lubrication residing between the shaft bearing surface and the sleeve bearing surface.

2. The disk drive pivot assembly of claim 1 further comprising:
at least one thrust plate coupled to the shaft and having a thrust plate bearing surface.

3. The disk drive pivot assembly of claim 2 wherein the sleeve further includes a second sleeve bearing surface, the disk drive pivot assembly further comprising:
a second solid lubrication residing between the thrust plate bearing surface and the second sleeve bearing surface.

4. The disk drive pivot assembly of claim 3 wherein the second solid lubrication is affixed to at least one of the thrust plate bearing surface and the second sleeve bearing surface.

5. The disk drive pivot assembly of claim 2 further comprising:
at least one counterplate coupled to the sleeve and having a counterplate bearing surface.

6. The disk drive pivot assembly of claim 5 wherein the sleeve further includes at least a second sleeve bearing surface, the disk drive pivot assembly further comprising:
a second solid lubrication residing between the thrust plate bearing surface and the counterplate bearing surface.

7. The disk drive pivot assembly of claim 6 wherein the second solid lubrication is affixed to at least one of the thrust plate bearing surface and the counterplate bearing surface.

8. The disk drive pivot assembly of claim 1 wherein the shaft further includes an extension configured to be affixed to a swing arm.

9. The disk drive pivot assembly of claim 1 wherein the solid lubrication is affixed to at least one of the shaft bearing surface and the sleeve bearing surface.

10. The disk drive pivot assembly of claim 1 wherein the shaft is immobile with respect to a disk drive base plate.

11. The disk drive pivot assembly of claim 1 wherein the sleeve is immobile with respect to a disk drive base plate.

12. The disk drive pivot assembly of claim 1 wherein the shaft further includes a recessed portion defining a gap between the shaft and the sleeve, the recessed portion of the shaft not including the shaft bearing surface.

13. The disk drive pivot assembly of claim 12 wherein the shaft further includes a second shaft bearing surface and wherein the sleeve further includes a second sleeve bearing surface defining at least a second portion of the aperture.

14. The disk drive pivot assembly of claim 13 further comprising:
a second solid lubrication residing between the second shaft bearing surface and the second sleeve bearing surface.

15. The disk drive pivot assembly of claim 1 wherein the shaft further includes:
an end having a shoulder portion.

16. A method for providing a disk drive pivot assembly comprising:
providing a sleeve having a sleeve bearing surface defining at least a portion of an aperture within the sleeve;
providing a shaft having a shaft bearing surface and being rotatable with respect to the sleeve, the shaft bearing surface abutting the sleeve bearing surface;
providing a solid lubrication residing between the shaft bearing surface and the sleeve bearing surface.

17. The method of claim 16 further comprising:
at least one thrust plate coupled to the shaft and having a thrust plate bearing surface.

18. The method of claim 17 wherein the sleeve further includes a second sleeve bearing surface, the method further comprising:
providing a second solid lubrication residing between the thrust plate bearing surface and the second sleeve bearing surface.

19. The method of claim 18 wherein the second solid lubrication is affixed to at least one of the thrust plate bearing surface and the second sleeve bearing surface.

20. The method of claim 17 further comprising:
providing at least one counterplate coupled to the sleeve and having a counterplate bearing surface.

21. The method of claim 20 wherein the sleeve further includes at least a second sleeve bearing surface, the method further comprising:
providing a second solid lubrication residing between the thrust plate bearing surface and the counterplate bearing surface.

22. The method of claim 21 wherein the second solid lubrication is affixed to at least one of the thrust plate bearing surface and the counterplate bearing surface.

23. The method of claim 15 wherein the shaft further includes an extension configured to be affixed to a swing arm.

24. The method of claim 15 wherein the solid lubrication is affixed to at least one of the shaft bearing surface and the sleeve bearing surface.

25. The method of claim 15 wherein the shaft is immobile with respect to a disk drive base plate.

26. The method of claim 15 wherein the sleeve is immobile with respect to a disk drive base plate.

27. The method of claim 15 wherein the shaft further includes a recessed portion defining a gap between the shaft and the sleeve, the recessed portion of the shaft not including the shaft bearing surface.

28. The method of claim 27 wherein the shaft further includes a second shaft bearing surface and wherein the sleeve further includes a second sleeve bearing surface defining at least a second portion of the aperture.

29. The method of claim 28 further comprising:
providing a second solid lubrication residing between the second shaft bearing surface and the second sleeve bearing surface.

30. The method of claim 15 wherein the shaft providing further includes:
providing an end having a shoulder portion.
